(19) United States
(12) Patent Application Publication
(10) Pub. No.: US 2009/0020268 A1
(43) Pub. Date: Jan. 22, 2009

(54) GROOVED HEAT PIPE AND METHOD FOR MANUFACTURING THE SAME

(75) Inventors: CHANG-SHEN CHANG, Tu-Cheng (TW); CHAO-HAO WANG, Tu-Cheng (TW); JUEI-KHAI LIU, Tu-Cheng (TW); HSIEN-SHENG PEI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Tu-Cheng (TW)

(21) Appl. No.: 11/857,407

(22) Filed: Sep. 18, 2007

(30) Foreign Application Priority Data
Jul. 20, 2007 (CN) 200710076092.1

(51) Int. Cl. F28D 15/04; B23P 17/04; F28D 15/00

(52) U.S. Cl. 165/104.26; 165/104.33; 29/592

(57) ABSTRACT

A heat pipe (10) includes a casing (11) and a composite wick structure (14). The casing includes an evaporator section (15) and a condenser section (16). The wick structure includes a plurality of grooves (142, 143) and an artery mesh (145). The grooves at the evaporator section each have a smaller groove width and a smaller apex angle (A1) than those of each of the grooves at the condenser section. A method for manufacturing the heat pipe includes: providing a casing with a plurality of grooves axially defined therein; shrinking a diameter of one portion of the casing to obtain an evaporator section of the heat pipe; placing an artery mesh to contact with an inner wall of the casing; vacuuming the casing and placing a working fluid in the casing; sealing the casing to obtain the heat pipe.

### CROSS-REFERENCES TO RELATED APPLICATION

This application is related to co-pending U.S. patent application Ser. No. 11/309,301, filed on Jul. 24, 2006, and entitled “HEAT PIPE WITH COMPOSITE WICK STRUCTURE”; and co-pending U.S. patent application Ser. No. 11/556,613, filed on Nov. 3, 2006, and entitled “HEAT PIPE WITH VARIABLE GROOVED-WICK STRUCTURE AND METHOD FOR MANUFACTURING THE SAME”. The present application and the co-pending applications are assigned to the same assignee. The disclosure of the above-identified applications are incorporated herein by reference.

### BACKGROUND OF THE INVENTION

1. Field of the Invention

The present invention relates generally to grooved heat pipes, and more particularly to a grooved heat pipe with variable grooved-wick structure and an artery mesh for increasing heat transfer capability thereof.

2. Description of Related Art

Nowadays, thermal modules are widely used in notebook computers to dissipate heat generated by CPUs. The thermal module includes a blower, a fin assembly, and a heat pipe. The heat pipe has an evaporator section and a condenser section respectively connected with a CPU and the fin assembly so as to transfer heat generated by the CPU to the fin assembly. The fin assembly is arranged at an air outlet of the blower to dissipate heat absorbed from the condenser section of the heat pipe to the surrounding environment.

In the thermal module, the evaporator section of the heat pipe usually has a smaller area than the condenser section. Accordingly, a contacting area between the evaporator section of the heat pipe and the CPU is smaller than that between the condenser section of the heat pipe and the fin assembly. Therefore, the radial power density, which the evaporator section of the heat pipe undergoes, is greater than that the condenser section of the heat pipe needs to undergo.

In a conventional grooved heat pipe, grooves at the evaporator section thereof have similar groove shapes to grooves at the condenser section thereof. This means the evaporator section of the conventional grooved heat pipe has the same radial power density as the condenser section thereof, which limits the heat transfer capability of the conventional grooved heat pipe and further limits the heat dissipating efficiency of the thermal module. Thus, it can be seen that improvement of the radial power density of the evaporator section of the heat pipe is key to improve the heat dissipation efficiency of the thermal module.

### SUMMARY OF THE INVENTION

The present invention relates, in one aspect, to a heat pipe for removing heat from heat-generating components. The heat pipe includes a casing, a composite wick structure and a predetermined quantity of bi-phase working fluid contained in the casing. The casing includes a first portion and a second portion having a larger diameter than the first portion. The composite wick structure includes a plurality of grooves axially extending along an inner wall of the casing and at least an artery mesh contacting with some of ribs defining the grooves. The grooves at the first portion of the casing each have a smaller groove width and a smaller apex angle than those of each of the grooves at the second portion.

The present invention relates, in another aspect, to a method for manufacturing the heat pipe. The method for manufacturing the heat pipe includes: providing a casing with a plurality of tiny grooves axially extending along an inner wall thereof; shrinking a diameter of one portion of the casing via a shrinkage tool to enable it to function as an evaporator section of the heat pipe; placing at least an artery mesh to contact with the inner wall of the casing; vacuuming the casing and placing a predetermined quantity of working fluid in the casing; and sealing the casing to obtain the heat pipe. An apex angle of each of the grooves at the evaporator section is smaller than that of each of the grooves at another section of the heat pipe.

Other advantages and novel features of the present invention will become more apparent from the following detailed description of preferred embodiment when taken in conjunction with the accompanying drawings, in which:

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views:

FIG. 1 is a longitudinally cross-sectional view of a heat pipe in accordance with a preferred embodiment of the present invention;

FIG. 2 is an enlarged, transversely cross-sectional view of the heat pipe of FIG. 1, taken along line II-II;

FIG. 3 is an enlarged, transversely cross-sectional view of the heat pipe of FIG. 1, taken along line III-III;

FIG. 4 is an explanatory view illustrating a manufacturing phase of the heat pipe of FIG. 1;

FIG. 5 an enlarged, transversely cross-sectional view of FIG. 4, taken along line V-V;

FIG. 6 is an explanatory view illustrating a manufacturing phase of the heat pipe of FIG. 1 in accordance with an alternative embodiment;

FIG. 7 an enlarged, transversely cross-sectional view of FIG. 6, taken along line VII-VII;

FIG. 8 is a transversely cross-sectional view of a heat pipe in accordance with a second embodiment of the present invention; and

FIG. 9 is a transversely cross-sectional view of a heat pipe in accordance with a third embodiment of the present invention.

### DETAILED DESCRIPTION OF THE INVENTION

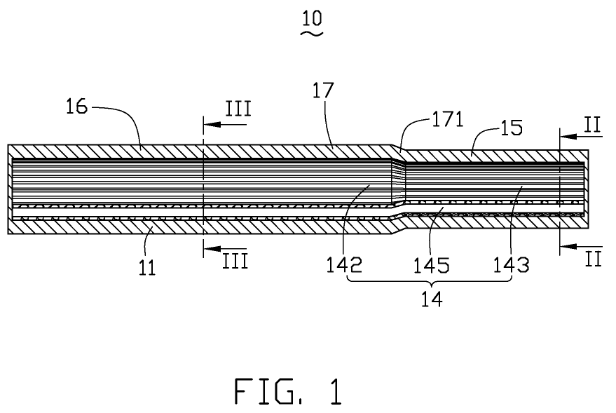

Referring to FIG. 1, a heat pipe 10 in accordance with a preferred embodiment of the present invention is shown. The heat pipe 10 includes a casing 11, a plurality of tiny grooves 143, 142 axially defined in an inner wall of the casing 11, an artery mesh 145 contacting with some of the tiny grooves 143, 142, and a predetermined quantity of bi-phase working fluid (not shown) filled in the casing. The tiny grooves 143, 142 and the artery mesh 145 cooperatively from a composite wick structure 14 for the heat pipe 10.

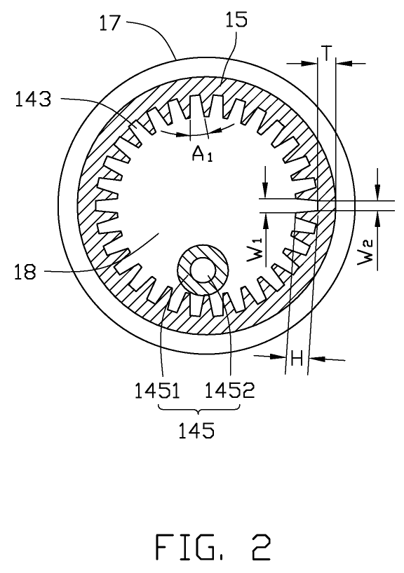

Also referring to FIG. 2, the casing 11 is a metallic hollow tube having a ring-like transverse cross section and a uniform thickness T through a length of the casing 11. The casing 11 includes an evaporator section 15 disposed at an end thereof, a condenser section 16 disposed at the other end thereof, and an adiabatic section 17 disposed between the evaporator and the condenser sections 15, 16. Diameters of inner and outer surfaces of the evaporator section 15 are smaller than inner and outer surfaces of the condenser section 16, respectively. A transition section 171 is formed between the evaporator section 15 and the adiabatic section 17. A diameter of the transition section 171 is gradually decreased from the adiabatic section 17 towards the evaporator section 15 so that the transition section 171 has a taper-shaped configuration towards the evaporator section 15. Alternatively, the transition section 171 can be formed at other portion of the heat pipe 10, such as a portion between the adiabatic section 17 and the condenser section 16, or a portion of the adiabatic section 17.

The working medium is usually selected from a liquid which has a low boiling point and is compatible with the casing 11, such as water, methanol, or alcohol. Thus, the working medium can easily evaporate to vapor when it receives heat in the evaporator section 15 and condense to liquid when it dissipates heat in the condenser section 16.

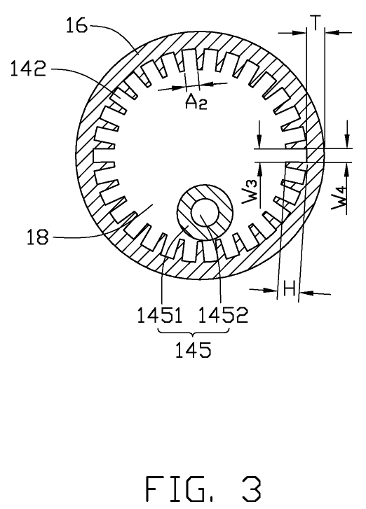

Referring to FIGS. 2 and 3, the grooves 143, 142 are coextensive with a central, longitudinal axis of the casing 11. The grooves 143 are defined in the evaporator section 15, whilst the grooves 142 are defined in the condenser and the adiabatic sections 16, 17. The grooves 143 at the evaporator section 15 of the casing 11 have a height H which is substantially the same as a height H of the grooves 142 at the condenser section 16 thereof. An apex angle A1 of each of the grooves 143 at the evaporator section 15 is smaller than an apex angle A2 of each of the grooves 142 at the condenser section 16. A top width W₁ of each of the grooves 143 at the evaporator section 15 is smaller than a top width W₃ of each of the grooves 142 at the condenser section 16, whilst a bottom width W₂ of each of the grooves 143 at the evaporator section 15 is smaller than a bottom width W₄ of each of the grooves 142 at the condenser section 16. This means a middle width (groove width) of each of the grooves 143 at the evaporator section 15 is smaller than that of each of the grooves 142 at the condenser section 16.

The artery mesh 145 is an elongate, flexible tube, which contacts with some of ribs (not labeled) defining the grooves 142, 143 and axially extends along the inner wall of the casing 11. The artery mesh 145 is formed by weaving a plurality of metal wires such as cooper wires or stainless steel wires, or by weaving a plurality of non-metal threads such as fiber wires. In this embodiment, the artery mesh 15 is formed by weaving a plurality of copper wires each having a diameter of 0.05 mm. A thickness of a periphery wall 1451 of the artery mesh 145 is 0.2 mm and a plurality of pores (not shown) are defined in the periphery wall 1451. A central passage 1452 is defined in an inner space of the artery mesh 145. The pores communicate the central passage 1452 with the grooves 142, 143 of the casing 11. A diameter of the central passage 1452 of the artery mesh 145 is in a range from 0.5 mm to 10 mm. The size of the diameter of the central passage 1452 varies due to the kind of the working fluid filled in the casing 11. When the working fluid is water, the diameter of the central passage 1452 is preferably in the range from 0.5 mm to 2 mm. In this embodiment, the diameter of the central passage 1452 is 1 mm. Since the diameter of the central passage 1452 is small, capillary force generated by the pores of the artery mesh 145 draws the condensed working fluid filled in the central passage 1452 of the artery mesh 145 to flow along the central passage 1452. Therefore, the condensed working fluid can flow from the condenser section 16 towards the evaporator section 15 via the central passage 1452. The vaporized working fluid in the evaporator section 15 merely flow towards the condenser section 16 via a vapor channel 18 formed between the inner wall of the casing 11 and the periphery wall 1451 of the artery mesh 145. This prevents the vaporized working fluid from entering into the central passage 1452 and further prevents the vaporized working fluid from mixing up with the condensed working fluid. Thus, the heat transfer capability of the heat pipe 10 is increased. In addition, a diameter of an outer surface of the artery mesh 145 is much less than a diameter of the inner surface of the casing 11. A bottom portion of the artery mesh 145 contacts with the inner surface of the casing 11, whilst the other portion of the artery mesh 145 distant from the inner surface of the casing 11. Therefore, the artery mesh 145 can not be damaged when the casing 11 of the heat pipe 10 is flattened. This increases heat transfer capability of the heat pipe 10 when the heat pipe 10 is flattened.

The present invention also provides a method for manufacturing the heat pipe 10. The present heat pipe 10 is manufactured by such steps: providing a metal casing 11 with a uniform diameter along a longitudinal direction thereof; forming a plurality of tiny grooves in the inner wall of the casing 11; shrinking the diameter of one portion of the casing 11 so as to allow the portion of the casing 11 to function as the evaporator section 15 of the heat pipe 10; placing an artery mesh 145 in the casing 11 of the heat pipe 10 and keeping the artery mesh 145 axially extending along the inner wall of the casing 11; heating the artery mesh 145 and the casing 11 so as to bond the artery mesh 145 onto the inner wall of the casing 11; vacuuming the casing 11 and then placing the predetermined quantity of the working fluid into the casing 11; sealing the casing 11 to obtain the heat pipe 10. Each of the grooves at the evaporator section 15 has an apex angle and a groove width smaller than those of each of the grooves at another section of the heat pipe 10.

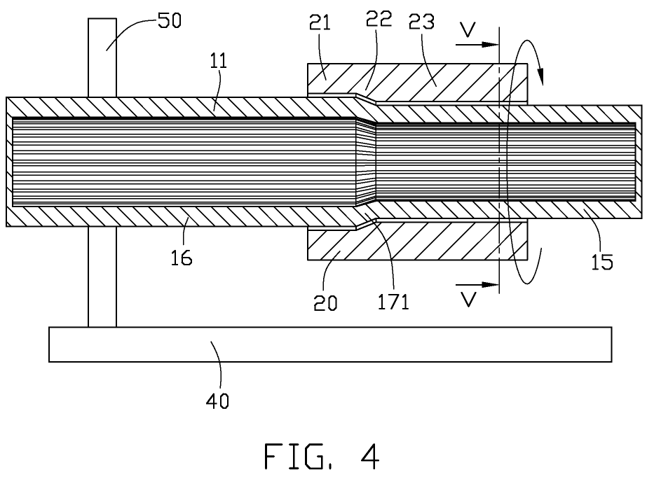

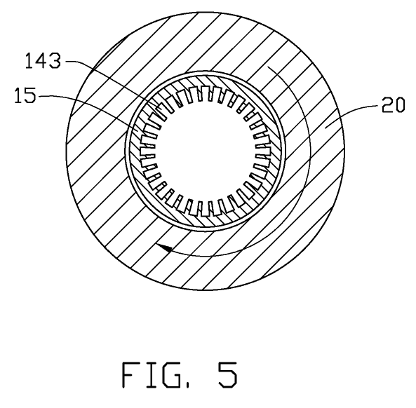

Referring to FIGS. 4 and 5, the evaporator section 15 of the heat pipe 10 can be shrunk by a treatment of a high speed spinning tube shrinkage. A high speed spinning tube shrinkage tool 20 is a hollow tube which includes a tapered portion 22 corresponding to the transition section 171 of the heat pipe 10, and guiding and diminishing portions 21, 23 corresponding to the respective condenser and evaporator sections 16, 15 of the heat pipe 10. The guiding portion 21 connects with a front end of the transition section 171, and the diminishing portion 23 connects with a rear end of the transition section 171. A diameter of an inner wall of the guiding portion 21 of the high speed spinning tube shrinkage tool 20 is substantially equal to a diameter of an outer wall of the condenser section 16. A diameter of an inner wall of the diminishing portion 23 of the high speed spinning tube shrinkage tool 20 is substantially equal to a diameter of an outer wall of the evaporator section 15 of the heat pipe 10. The tapered portion 22 enables to gradually diminish the diameter of the outer wall of the evaporator section 15 so as to form the transition section 171. In shrinkage of the original evaporator section of the casing 11, the casing 11 of the heat pipe 10 is fixed to a work table 40 via two fixing members 50; the high speed spinning tube shrinkage tool 20 is propelled to move a distance from the evaporator section 15 towards the condenser section 16 of the casing 11 along the central, longitudinal axis thereof. In movement of the tool 20, the guiding portion 21 guides the movement of the tool 20 over the casing 11. Meanwhile, the diminishing portion 23 compresses the outer wall of the evaporator section 15 so as to shrink the diameter thereof and thereby obtain the needed heat pipe 10.

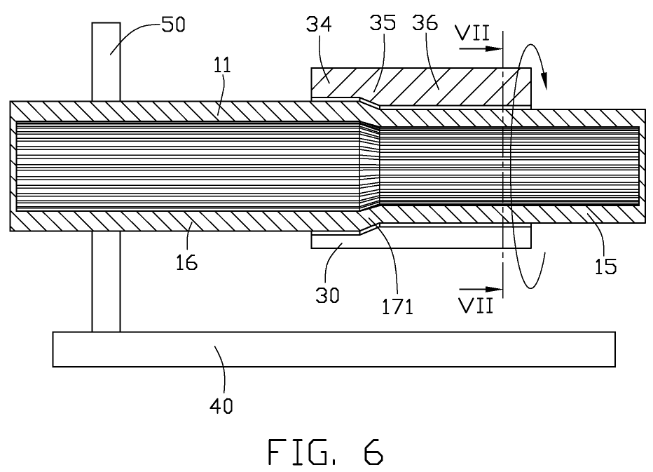

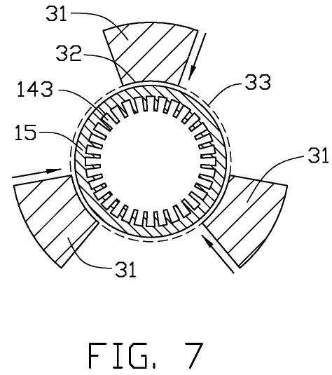

Referring to FIGS. 6 and 7, the evaporator section 15 of the heat pipe 10 can also be shrunk by a treatment using a spinning stamping tube shrinkage. A spinning stamping tube shrinkage tool 30 includes three sub-tools 31 with arc-shaped inner surfaces 32 thereof evenly distributed around an imaginary circle 33, which is coaxial with and surrounds the casing 11. The tool 30 includes a tapered portion 35 corresponding to the transition section 171 of the heat pipe 10, and guiding and diminishing portions 34, 36 corresponding to the respective condenser and evaporator sections 16, 15 of the heat pipe 10. A diameter of the tapered portion 35 is gradually increased from the diminishing portion 36 towards the guiding portion 34. A diameter of the diminishing portion 36 of the tool 30 at the imaginary circle 33 is greater than that of the evaporator section 15 of the casing 11 before the shrinkage operation, while a diameter of the diminishing portion 36 of the tool 30 is decreased to a predetermined value which is substantially equal to the diameter of the evaporator section 15 of the casing 11 after the shrinkage process. During shrinkage of the evaporator section 15 of the casing 11, the casing 11 of the heat pipe 10 is fixed to a work table 40 via a fixing member 50; the three sub-tools 31 are rotated and at the same time are controlled to move towards the evaporator section 15 of the casing 11 along a radial direction of the casing 11 so as to shrink the diameter of the casing 11 at the evaporator section 15. Meanwhile, the sub-tools 31 may be controlled to move towards the evaporator section 15 of the casing 11 along the central, longitudinal axis of the heat pipe 10 in order to obtain a predetermine length for the evaporator section 15. In shrinkage of the evaporator section 15 of the casing 11, the diameter of the imaginary circle 33 is gradually decreased to the predetermined value.

In the present heat pipe 10, each of the grooves 143 at the evaporator section 15 has a smaller groove width and a smaller apex angle than those of each of the grooves 142 at the condenser section 16. This increases the density of the grooves 143 at the evaporator section 15 of the heat pipe 10. The radial power density the evaporator section 15 of the heat pipe 10 can undergo is therefore increased, and the thermal resistance of the evaporator section 15 of the heat pipe 10 is decreased. Thus, the heat transfer capability of the heat pipe 10 is improved. In addition, the wicking ability of the grooves 143 at the evaporator section 15 of the heat pipe 10 is increased, which increases the heat transfer capabilities of the heat pipe 10. The heat transfer capability of the heat pipe 10 is not lowered after the shrinkage of the evaporator section 15 of the heat pipe 10 in accordance with the present invention, which simplifies the manufacturing of the heat pipe 10. In this way the present heat pipe 10 is suitable for mass production.

In the present heat pipe 10, the evaporator section 15 and the condenser section 16 are respectively disposed at two ends of the casing 11. Alternatively, the casing may include two condenser sections disposed at two ends thereof, and an evaporator section arranged between the condenser sections. Two transition sections are respectively disposed between the evaporator section and the condenser sections. Under this status, the evaporator section of the casing is shrunk by spinning stamping tube shrinkage treatment. In order to manufacture this kind of the heat pipe, the spinning stamping tube shrinkage tool may include a diminishing portion, two guiding portions disposed at two sides of the diminishing portion, and two tapered portions respectively formed between the diminishing portion and the guiding portions. Furthermore, the heat pipe can be bent to L-shaped or U-shaped to satisfy different applications for the heat pipe.

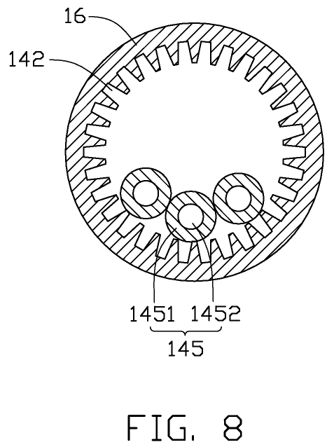

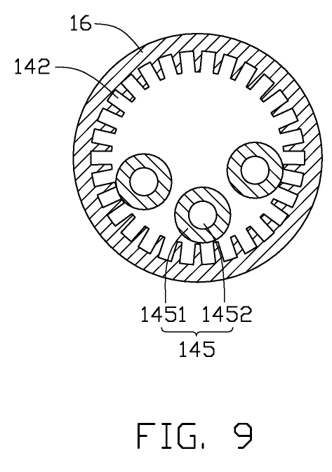

In the present heat pipe 10, there is one artery mesh 145 arranged in the casing 10. Alternatively, there may be several artery meshes 145 arranged in the casing 10. Referring to FIG. 8, there are three artery meshes 145 in the casing 10. The artery meshes 145 are disposed around the central, longitudinal axis of the casing 10, with adjacent artery meshes 145 contacting with each other. Referring to FIG. 9, there are three spaced artery meshes 145 in the casing 10. The artery meshes 145 are disposed around the central, longitudinal axis of the casing 10, with each of them spacing a distance from an adjacent artery mesh 145.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat pipe comprising:
a casing comprising a first portion and a second portion having a larger diameter than the first portion;
a composite wick structure comprising a plurality of grooves axially extending along an inner wall of the casing and at least an artery mesh contacting with some of ribs defining the grooves, the grooves at the first portion of the casing each having a smaller groove width than each of the grooves at the second portion; and
a predetermined quantity of bi-phase working fluid contained in the casing;
wherein the artery mesh defines a central passage for transportation of condensed bi-phase working fluid from the second portion to the first portion.

2. The heat pipe of claim 1, wherein the grooves at the first portion of the casing each have a smaller apex angle than each of the grooves at the second portion.

3. The heat pipe of claim 1, wherein the first portion is an evaporator section of the heat pipe, whilst the second section is a condenser section of the heat pipe.

4. The heat pipe of claim 1, further comprising a transition section disposed between the first portion and the second portion, a diameter of the transition section being gradually decreased from the second portion towards the first portion.

5. The heat pipe of claim 1, wherein the at least an artery mesh comprises a plurality of woven wires selected from a group consisting of copper wires, stainless steel wires and fiber wires.

6. The heat pipe of claim 1, wherein the at least an artery mesh has a plurality of pores communicating the passage with the grooves.

7. The heat pipe of claim 6, wherein a diameter of the passage is in the range from 0.5 mm to 10 mm.

8. The heat pipe of claim 6, wherein the working fluid is water and a diameter of the passage is in the range from 0.5 mm to 2 mm.

9. The heat pipe of claim 6, wherein a diameter of the at least an artery mesh is much less than that of the casing.

10. The heat pipe of claim 1, wherein the at least an artery mesh comprises a plurality of spaced artery meshes.

11. A method for manufacturing a heat pipe comprising the steps of:
providing a casing with a plurality of tiny grooves axially extending along an inner wall thereof;
shrinking a diameter of one portion of the casing via a shrinkage tool to enable it to function as an evaporator section of the heat pipe;
placing at least an artery mesh to contact with the inner wall of the casing;
vacuuming the casing and placing a predetermined quantity of working fluid in the casing; and
sealing the casing to obtain the heat pipe;
wherein each of the grooves at the evaporator section has a smaller width than each of the grooves at another section of the heat pipe.

12. The method as described in claim 11, wherein the shrinkage tool is a high speed spinning tube shrinkage tool, and the shrinkage process of the evaporator section comprises the step of controlling the high speed spinning tube shrinkage tool to move towards the evaporator section of the casing along a central, longitudinal axis thereof so as to shrink the diameter thereof, the high speed spinning tube shrinkage tool comprising a diminishing portion which is able to compress an outer wall of the evaporator section so as to shrink the diameter thereof and a guiding portion which guides the movement of the high speed spinning tube shrinkage tool over the casing, the guiding portion having an inner diameter substantially equal to an outer diameter of the casing.

13. The method as described in claim 11, wherein the shrinkage tool is a spinning stamping tube shrinkage tool, and the shrinkage process of the evaporator section comprises the step of controlling the spinning stamping tube shrinkage tool to move towards the evaporator section of the casing along a radial direction of the casing so as to shrink the diameter of the evaporator section, the spinning stamping tube shrinkage tool comprising more than two sub-tools with arc-shaped inner surfaces thereof distributed around an imaginary circle which is coaxial with and surrounds the casing, each of the sub-tools comprising a diminishing portion and a tapered portion connecting with the diminishing portion at an end thereof, a diameter of the tapered portion being gradually increased from the end towards an opposite end thereof.

14. The method as described in claim 13, wherein the shrinkage process of the evaporator section further comprises the step of controlling the spinning stamping tube shrinkage tool to move towards the evaporator section of the casing along a central, longitudinal axis of the heat pipe in order to obtain a predetermine length for the evaporator section.

15. The method as described in claim 1, wherein each of the grooves at the evaporator section has an apex angle smaller than that of each of the grooves at the another section of the heat pipe.

16. The method as described in claim 11, wherein the at least an artery mesh comprises a plurality of woven wires selected from a group consisting of copper wires, stainless steel wires and fiber wires and has a diameter much less than that of the casing.

17. The method as described in claim 11, wherein the at least an artery mesh has an inner passage for condensed working fluid to flow therein, and a plurality of pores communicating the passage with the grooves.

18. A heat pipe comprising:
a metal casing having an evaporator section for absorbing heat and a condenser section for dissipating heat, the evaporator section having a diameter smaller than that of the condenser section;
a plurality of grooves being formed in an inner wall of the metal cashing and extending from the evaporator section to the condenser section, wherein each of the grooves at the evaporator section has a width and an apex angle smaller than those of each of the grooves at the condenser section; and
working fluid filled in the casing.

19. The heat pipe as described in claim 18 further comprising an artery mesh received in the casing, the artery mesh defining a central passage through which condensed working fluid flows from the condenser section to the evaporator section.

20. The heat pipe as described in claim 19, wherein the artery mesh comprises a plurality of woven wires.
